(19) United States
(12) Patent Application Publication
(10) Pub. No.: US 2012/0159749 A1
(43) Pub. Date: Jun. 28, 2012

(54) CLIPPING DEVICE

(75) Inventors: Norihito ITOU, Okazaki-shi (JP); Katsuya HIRAKAWA, Toyokawa-shi (JP)

(73) Assignee: DAIWA KASEI KOGYO KABUSHIKI KAISHA, Aichi-ken (JP)

(21) Appl. No.: 13/332,091

(22) Filed: Dec. 20, 2011

(30) Foreign Application Priority Data
Dec. 24, 2010 (JP) 2010-287555

(51) Int. Cl. F16B 2/20

(52) U.S. Cl. 24/457

(57) ABSTRACT

A spring clip capable of being fitted to a plate-shaped member may include a pair of pinching members that are configured to receive the plate-shaped member in a space formed therebetween when the spring clip is fitted to the plate-shaped member, and at least one engagement strip that is formed in the pinching members so as to be projected into the space formed between the pinching members. The at least one engagement strip is arranged and constructed to be elastically deformed when the plate-shaped member is received in the space formed between the pinching members, so that a contacting peripheral edge of the at least one engagement strip can be elastically pressed to the plate-shaped member. The at least one engagement strip has a weakened portion formed in a proximal end portion thereof, so as to be easily deformed.

### BACKGROUND OF THE INVENTION

1. Field of the Invention

The present invention relates to a clipping device that is configured to be connected to a subject member (e.g., an instrument panel of a vehicle) in order to attach an attached article (e.g., a wiring harness) to the subject member. More particularly, the present invention relates to a clipping device that has a spring clip capable of engaging and pinching a plate-shaped projection formed in a subject member in order to attach an attached article to the subject member.

2. Description of Related Art

This type of clipping device is already known and is taught, for example, by Japanese Laid-Open Patent Publication No. 11-55835. As shown in FIG. 8, a known clipping device 100 is composed of an integrally formed spring clip 110 and an integrally formed clip body 120. The spring clip 110 is made of steel and has a substantially U-shape in cross section. Conversely, the clip body 120 is made of resin and has a substantially U-shape in cross section corresponding to a shape of the spring clip 110. The spring clip 110 is coupled to the clip body 120 while the spring clip 110 is closely fitted within the clip body 120.

In particular, the spring clip 110 includes a pair of pinching members 111 each having an engagement strip 112. The pinching members 111 are positioned opposite to each other and are arranged and constructed to engage and pinch a plate-shaped rib R formed in an instrument panel IP (a subject member) of a vehicle when the spring clip 110 is attached thereto. The engagement strips 112 are formed by partially stamping out the pinching members 111 and are shaped to be projected inwardly and downwardly and opposite to each other. Further, each of the engagement strips 112 has engagement teeth 112A that are formed in a distal end thereof. The engagement strips 112 are configured such that when the pinching members 111 are engaged with the rib R of the instrument panel IP while being spread outwardly, the engagement teeth 112A can be elastically pressed to and bitten into plate surfaces Rs of the rib R due to elastic restoring forces of the pinching members 111. Further, the clip body 120 is shaped to be connected to a wiring harness WH or other such articles (an attached article) using a tying band T or other such tying devices.

In order to attach the wiring harness WH to the instrument panel IP, the clip body 120 is connected to the wiring harness WH using the tying band T, so that the clipping device 100 can be integrated with the wiring harness WH. Thereafter, the spring clip 110 is fitted to the rib R of the instrument panel IP while the pinching members 111 engage and pinch the rib R. As a result, the clipping device 100 can be secured to the instrument panel IP. Thus, the wiring harness WH can be attached to the instrument panel IP via the clipping device 100.

However, in the clipping device 100 thus constructed, each of the engagement strips 112 of the pinching members 111 generally has a high rigidity. Therefore, the spring clip 110 may have a large insertion resistance when the spring clip 110 is fitted to the rib R of the instrument panel IP. In other words, a large insertion load (force) can be required in order to fit the spring clip 110 to the rib R by engaging the pinching members 111 of the spring clip 110 with the rib R. As a result, working efficiency of a clip insertion operation can be reduced.

Thus, there is a need in the art for improved clipping devices.

### SUMMARY OF THE INVENTION

In one embodiment of the present invention, a spring clip capable of being fitted to a plate-shaped member may include a pair of pinching members that are configured to receive the plate-shaped member in a space formed therebetween when the spring clip is fitted to the plate-shaped member, and at least one engagement strip that is formed in the pinching members so as to be projected into the space formed between the pinching members. The at least one engagement strip is arranged and constructed to be elastically deformed when the plate-shaped member is received in the space formed between the pinching members, so that a contacting peripheral edge of the at least one engagement strip can be elastically pressed to the plate-shaped member due to an elastically biasing force that can be produced by deformation of the at least one engagement strip. The at least one engagement strip has a weakened portion formed in a proximal end portion thereof, so as to be easily deformed.

According to this embodiment, when the spring clip is pressed toward the plate-shaped member with applying an insertion load (force) thereto, the at least one engagement strip can be easily elastically deformed by the plate-shaped member because the weakened portion is formed therein. Therefore, an insertion resistance of the spring clip can be reduced. As a result, the insertion load that is required to fit the spring clip to the plate-shaped member can be effectively reduced.

To the contrary, when an extraction force is applied to the spring clip in a condition in which the spring clip is fitted to the plate-shaped member, because the contacting peripheral edge of the at least one engagement strip is elastically pressed to the plate-shaped member, the at least one engagement strip can be deformed while rotating about the contacting peripheral edge thereof in a rising direction with respect to the plate-shaped member, so that the pinching members can be widely spread. As a result, the contacting peripheral edge of the at least one engagement strip can be strongly pressed to the plate-shaped member. Thus, even when the extraction force is applied to the spring clip, the spring clip can be effectively prevented from being slipped off from the plate-shaped member.

Optionally, the at least one engagement strip may be formed by partially cutting out the pinching members. The weakened portion may be formed by forming a removed portion in the proximal end portion of the at least one engagement strip.

Further, the at least one engagement strip may be formed by stamping out the pinching members. The at least one engagement strip may be stamped out such that a rounded shear drop can be formed in the contacting peripheral edge of the at least one engagement strip.

Other objects, features and advantages of the present invention will be readily understood after reading the following detailed description together with the accompanying drawings and the claims.

### BRIEF DESCRIPTION OF THE DRAWINGS

FIG. 1 is a perspective view of a clipping device according to a first representative embodiment of the present invention, which view illustrates a condition in which the clipping device is secured to an instrument panel, so that a wiring harness is attached thereto;

FIG. 2 is a perspective view of a spring clip of the clipping device in a condition in which the clipping device is not secured to the instrument panel;

FIG. 3 is an exploded perspective view of the clipping device;

FIG. 4 is a side view of the spring clip of the clipping device;

FIG. 5(A) is an elevational view of the spring clip, which view illustrates a condition in which the spring clip is not fitted to a rib of the instrument panel;

FIG. 5(B) is an enlarged view of an encircled portion V(B) of FIG. 5(A);

FIG. 5(C) is an enlarged view of an encircled portion V(C) of FIG. 5(A);

FIG. 6(A) is an elevational view of the spring clip, which view illustrates a condition in which the spring clip is fitted to the rib of the instrument panel;

FIG. 6(B) is an enlarged view of an encircled portion VI(B) of FIG. 6(A);

FIG. 6(C) is an enlarged view of an encircled portion VI(C) of FIG. 6(A);

FIG. 7(A) is an elevational view of the spring clip, which view illustrates a condition in which an extraction force is applied to the spring clip that is fitted to the rib of the instrument panel;

FIG. 7(B) is an enlarged view of an encircled portion VII(B) of FIG. 7(A);

FIG. 7(C) is an enlarged view of an encircled portion VII(C) of FIG. 7(A); and

FIG. 8 is a perspective view of a spring clip of a conventional clipping device in a condition in which the clipping device is not secured to an instrument panel.

### DETAILED DESCRIPTION OF THE INVENTION

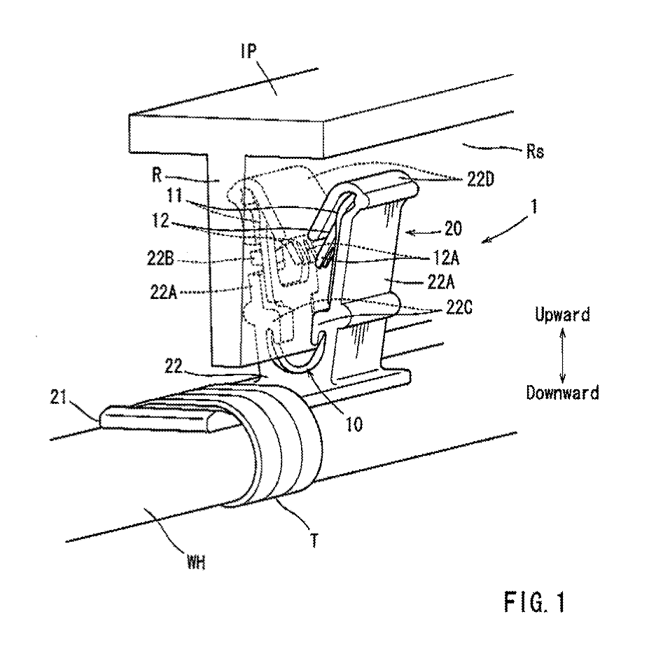

A detailed representative embodiment of the present invention will be described with reference to FIGS. 1 to 7(C).

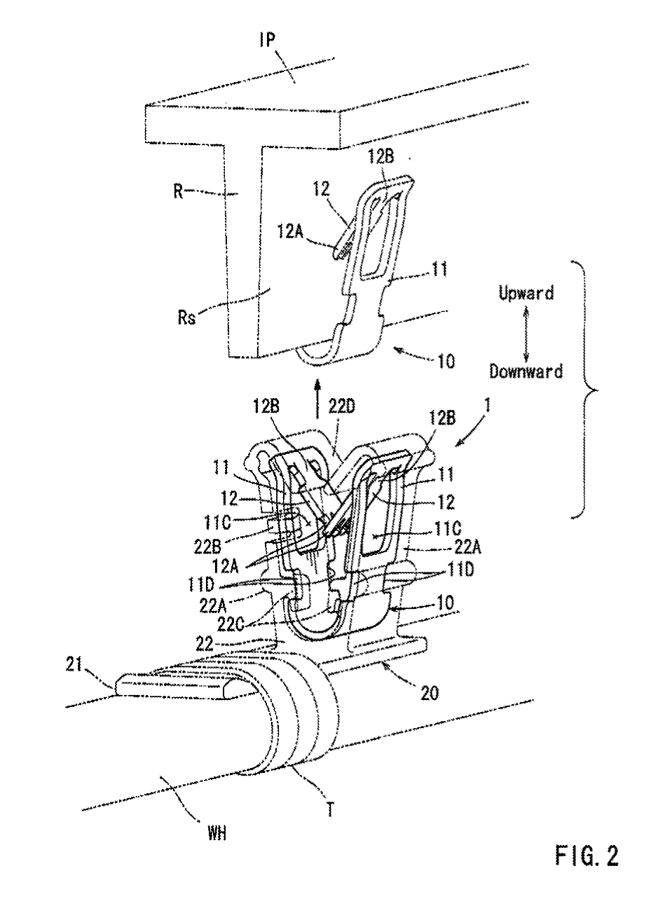

As shown in FIGS. 1 and 2, a representative clipping device 1 may preferably be configured to be connected to an instrument panel IP (a subject member) of a vehicle in order to attach a wiring harness WH (an attached article) to the instrument panel IP. The clipping device 1 may be composed of an integrally formed spring clip 10 and an integrally formed clip body 20. The spring clip 10 is made of steel. Conversely, the clip body 20 is made of synthetic resin. The spring clip 10 is coupled to and integrated with the clip body 20 while the spring clip 10 is closely fitted within the clip body 20.

In order to attach the wiring harness WH to the instrument panel IP, the clip body 20 is connected to the wiring harness WH using a tying band T such as an adhesive tape, so that the clipping device 1 can be integrated with the wiring harness WH. Thereafter, the spring clip 10 of the clipping device 1 is fitted to a rib R formed in the instrument panel IP. As a result, the clipping device 1 can be secured to the instrument panel IP, so that the wiring harness WH can be attached to the instrument panel IP via the clipping device 1. Further, the rib R may be referred to as “a plate-shaped member.”

Further, the instrument panel IP may generally be made of synthetic resin such as polypropylene. Further, the rib R of the instrument panel IP may preferably be shaped such that a thickness thereof can be reduced from a proximal end toward a distal end. That is, the rib R of the instrument panel IP may preferably be shaped such that the spring clip 10 can be easily fitted thereto.

Next, a structure of each of the spring clip 10 and the clip body 20 constituting the clipping device 1 will be described in detail.

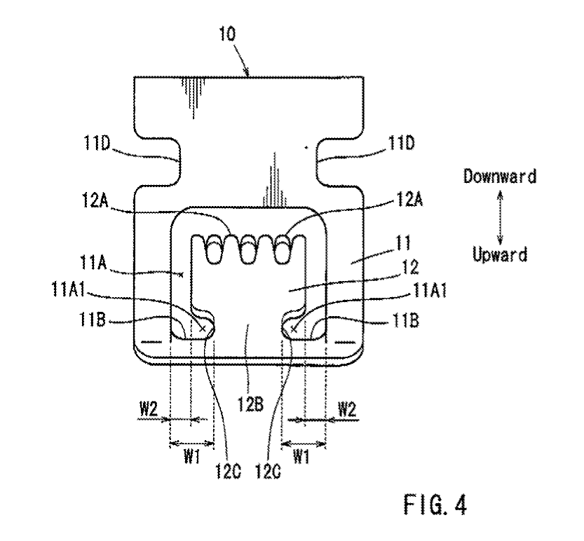

As shown in FIGS. 2 to 4, the spring clip 10 may preferably be formed by stamping out a steel sheet in a predetermined stamping direction using a pressing machine to form a blank and then by bending the blank in a direction opposite to the stamping direction using a bending machine to shape the blank to an open-topped substantially U-shape in cross section. The spring clip 10 thus formed may include a pair of pinching members 11 and may have an upper opening. The pinching members 11 may be positioned opposite to each other and may be elastically flexed inwardly and outwardly, so as to be expanded and contracted. The pinching members 11 may respectively have engagement strips 12. The engagement strips 12 may be formed by partially stamping out the pinching members 11 and may be shaped to be projected inwardly and downwardly and opposite to each other. In particular, open-topped U-shaped slots 11A may respectively be formed in the pinching members 11, so as to form cantilevered strips therein (FIG. 4). The cantilevered strips thus formed may then be bent inwardly about proximal end portions thereof. Thus, the engagement strips 12 can respectively be formed in the pinching members 11. Further, the pinching members 11 may respectively have open portions 11C that can be produced by forming the engagement strips 12 therein.

As shown in FIGS. 2 to 4 and 5(A), the engagement strips 12 may respectively have comb-shaped engagement teeth 12A that are formed in distal ends thereof. As will be recognized, the engagement teeth 12A may preferably be simultaneously formed in the engagement strips 12 when the engagement strips 12 are formed by stamping out the pinching members 11. That is, each of the U-shaped slot 11A may be previously shaped to have portions corresponding to the engagement teeth 12A. Further, the engagement strips 12 may be projected opposite to each other such that the engagement teeth 12A formed therein can contact and mesh with each other. In other words, the engagement strips 12 may be projected opposite to each other so as to not have clearance therebetween.

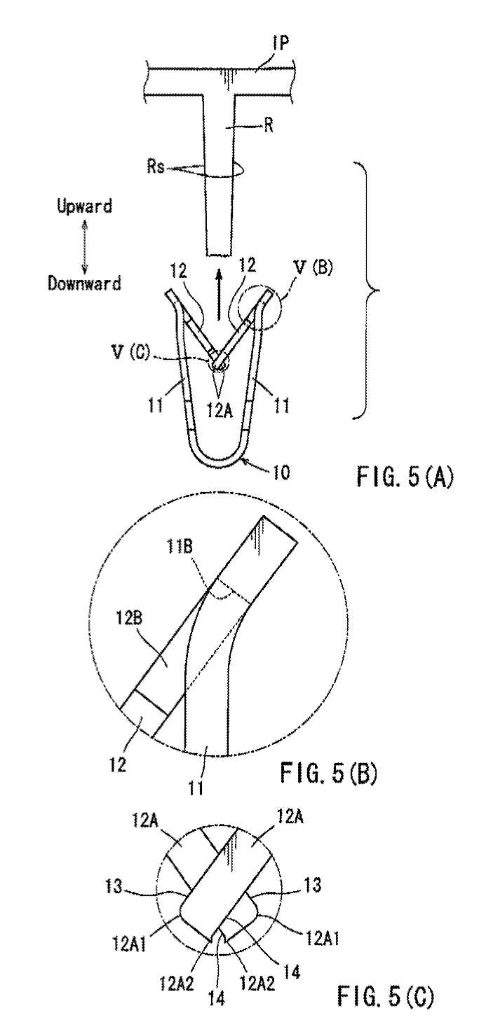

The engagement strips 12 may respectively be simultaneously formed in the pinching members 11 of the spring clip 10 when the spring clip 10 is formed by stamping out the steel sheet to form the blank. Further, as previously described, the spring clip 10 may be formed by stamping out the steel sheet in the stamping direction to form the blank and then by bending the blank in the direction opposite to the stamping direction. That is, the steel sheet may be stamped out from a surface that forms an inner surface of the spring clip 10 toward a surface that forms an outer surface of the spring clip 10. Therefore, as shown in FIG. 5(C), the engagement teeth 12A of each of the engagement strips 12 may have a rounded shear drop 12A1 that is formed in a peripheral edge corresponding to an inner surface 13 of each of the engagement strips 12, and a burr 12A2 that is formed in a peripheral edge corresponding to an outer surface 14 of each of the engagement strips 12. Further, in the engagement teeth 12A of each of the engagement strips 12, the peripheral edge having the shear drop 12A1 may be referred to as “a contacting peripheral edge.”

Further, as shown in FIG. 4, the slot 11A of each of the pinching members 11 may have widened end portions 11A1 each having a width W1 that is greater than a width W2 of a substantial portion of the slot 11A. Due to formation of the widened end portions 11A1 in the slot 11A, the engagement strip 12 of each of the pinching members 11 may have a notch or removed portion 12C that is formed in a proximal end portion 12B thereof. As a result, the proximal end portion 12B of the engagement strip 12 may be narrowed in width, so as to have a weakened portion. Therefore, the proximal end portion 12B can be relatively easily bent inwardly and outwardly, so that the engagement strip 12 can be relatively easily flexed inwardly and outwardly (when a load is applied to the engagement strip 12). Further, due to formation the widened end portions 11A1 in the slot 11A, each of upper thinned portions 11B (which may be referred to as engagement strip support portions) of each of the pinching members 11 may be lengthened to have an increased length that is identical to the width W1. Therefore, the upper thinned portions 11B can be relatively easily twisted when the load is applied to the engagement strip 12. As a result, the engagement strip 12 can be relatively easily flexed and deformed inwardly and outwardly when the load is applied to the engagement strip 12 because the thinned portions 11B may substantially function as retainer portions of the proximal end portion 12B of the engagement strip 12.

Further, as shown in FIG. 4, each of the pinching members 11 may have removed portions 11D that are formed in both sides thereof, so as to be easily flexed inwardly and outwardly.

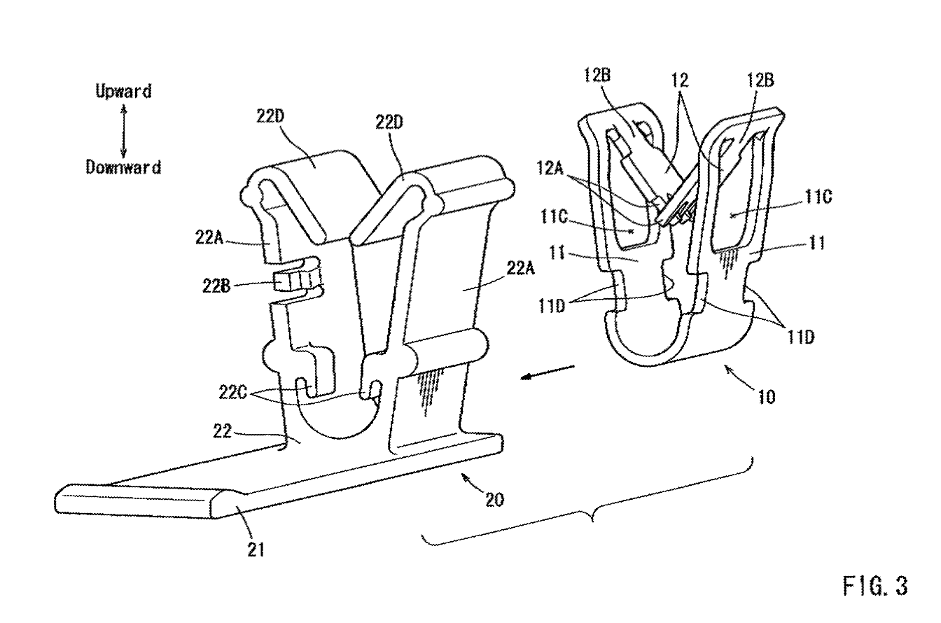

As shown in FIG. 3, the clip body 20 may preferably be formed by integral molding of synthetic resin. Further, the clip body 20 may have an attachment arm 21 that is connected to the wiring harness WH, and a clip holding portion 22 into which the spring clip 10 is fitted. The attachment arm 21 may be shaped to be stably connected to the wiring harness WH using the tying band T. Conversely, the clip holding portion 22 may be positioned on the attachment arm 21 and may have an open-topped substantially U-shape in cross section, which U-shape substantially corresponds to the U-shape of the spring clip 10. Further, the clip holding portion 22 may include a pair of holding strips 22A that are positioned opposite to each other. As will be recognized, the holding strips 22A may be arranged and constructed such that the spring clip 10 can be laterally (i.e., in a direction shown by arrow in FIG. 3) inserted into a space formed therebetween.

As shown in FIG. 3, the clip holding portion 22 may include an engagement portion 22B, a pair of stoppers 22C and a pair of engagement strip covering portions 22D. The engagement portion 22B may preferably be formed in one of the holding strips 22A of the clip holding portion 22. Further, the engagement portion 22B may be arranged and constructed to elastically engage one of the open portions 11C formed in the pinching members 11 of the spring clip 10 when the spring clip 10 is laterally inserted into the space formed between the holding strips 22A. In particular, the engagement portion 22B may preferably be formed as a cantilevered strip, so as to be elastically flexed inwardly and outwardly. Further, the engagement portion 22B may have a projection that is projected inwardly. The projection may be configured to snap-fit into one of the open portions 11C when the spring clip 10 is laterally inserted into the space formed between the holding strips 22A, so as to retain the spring clip 10 within the clip holding portion 22.

The stoppers 22C may respectively be formed in the holding strips 22A so as to be projected inwardly and opposite to each other. Further, the stoppers 22C may be arranged and constructed to engage the removed portions 11D respectively formed in the pinching members 11 of the spring clip 10 when the spring clip 10 is laterally inserted into the space formed between the holding strips 22A, so as to appropriately position the spring clip 10 within the clip holding portion 22.

The engagement strip covering portions 22D may respectively be formed in upper distal ends of the holding strips 22A so as to be projected inwardly and downwardly and opposite to each other. Further, the engagement strip covering portions 22D may respectively be arranged and constructed to cover the engagement strips 12 formed in the pinching members 11 of the spring clip 10 from above when the spring clip 10 is laterally inserted into the space formed between the holding strips 22A. Therefore, the wiring harness WH can be effectively prevented from being wedged between the engagement strips 12 of the pinching members 11 when the wiring harness WH provided with the clipping device 1 is transported. However, the engagement strip covering portions 22D may be arranged and constructed to be spaced from each other at a distance that is substantially identical to the thickness of the rib R formed in the instrument panel IP, so that the spring clip 10 of the clipping device 1 can be easily fitted to the rib R of the instrument panel IP.

Next, a method of using the clipping device 1 will now be described in detail.

First, as shown in FIG. 3, the spring clip 10 may be integrated with the clip body 20. In particular, the spring clip 10 may be laterally inserted into the space formed between the holding strips 22A of the holding portion of the clip body 20 until the removed portions 11D formed in the pinching members 11 of the spring clip 10 engage the stoppers 22C formed in the holding strips 22A of the holding portion 22. As a result, the spring clip 10 may be appropriately positioned within the clip holding portion 22. At this time, the projection of the engagement portion 22B formed in one of the holding strips 22A can be snap-fitted into one of the open portions 11C formed in the pinching members 11 of the spring clip 10, so that the spring clip 10 can be reliably retained within the clip holding portion 22 while the engagement strips 12 of the pinching members 11 are respectively covered by the engagement strip covering portions 22D. Thus, the spring clip 10 can be integrated with the clip body 20, so that the clipping device 1 can be formed. Further, as will be apparent from FIG. 3, the spring clip 10 has a substantially symmetrical shape. Therefore, the spring clip 10 can be inserted into the space formed between the holding strips 22A in an inverted posture.

In order to attach the wiring harness WH to the instrument panel IP, as shown by broken line in FIG. 2, the attachment arm 21 of the clip body 20 may be connected to the wiring harness WH using the tying band T, so that the clipping device 1 can be integrated with the wiring harness WH. At this time, no load may be applied to the engagement strip 12 of each of the pinching members 11 of the spring clip 10. Therefore, as shown in FIGS. 5(A) to 5(C), the engagement teeth 12A of the engagement strips 12 may still contact and mesh with each other. That is, the proximal end portions 12B of the engagement strips 12 may not be bent outwardly. Also, the upper thinned portions 11B of each of the pinching members 11 may not be twisted. As a result, the engagement strips 12 may not be flexed. Further, in FIGS. 5(A) to 5(C), the clip body 20, the wiring harness WH and the tying band T are omitted for simplification.

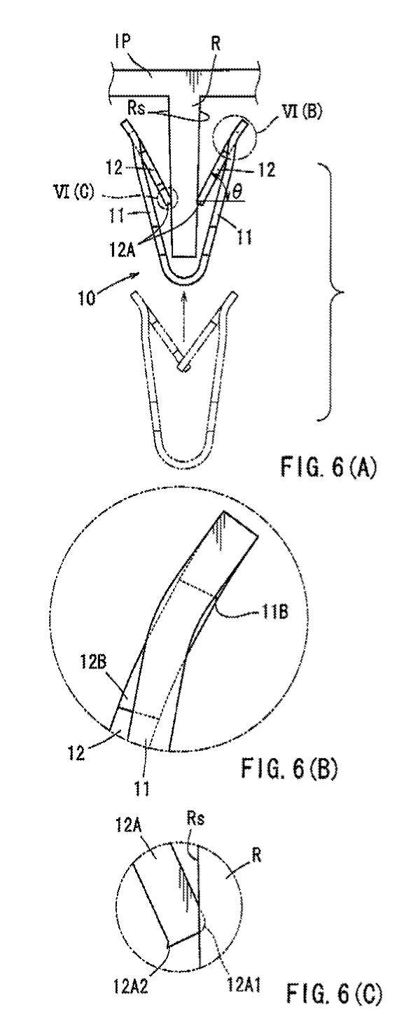

Thereafter, as shown in FIG. 6(A), the spring clip 10 of the clipping device 1 is pressed toward the rib R of the instrument panel IP upwardly (i.e., in a direction shown by broken line arrow) with applying an insertion force thereto. As a result, the spring clip 10 can be fitted to the rib R while the rib R is received in a space formed between the pinching members 11 of the spring clip 10. As a result, a load can be applied to the engagement strips 12 of the pinching members 11 via plate surfaces Rs of the rib R, so that the engagement strips 12 can be flexed outwardly while the pinching members 11 are spread outwardly. At this time, as shown in FIG. 6(B), the proximal end portions 12B of the engagement strips 12 can be bent outwardly. At the same time, the upper thinned portions 11B of each of the pinching members 11 can be twisted outwardly. Further, the engagement teeth 12A formed in each of the engagement strips 12 can be elastically pressed to and bitten into the plate surfaces Rs of the rib R due to an elastically biasing force that can be produced by deformation of the pinching members 11, the upper thinned portions 11B and the proximal end portions 12B of the engagement strips 12. In particular, as shown in FIG. 6(C), the engagement teeth 12A formed in each of the engagement strips 12 can be elastically pressed to the plate surfaces Rs of the rib R, so that the peripheral edges having the shear drops 12A1 (i.e., the contacting peripheral edge) can be bitten thereinto. As a result, the spring clip 10 of the clipping device 1 can be secured to the rib R of the instrument panel LP, so that an engagement condition of the spring clip 10 and the rib R can be obtained. Thus, the wiring harness WH can be attached to the instrument panel IP via the clipping device 1.

Further, the proximal end portion 12B of the engagement strip 12 can be relatively easily bent outwardly because the proximal end portion 12B is narrowed in width. At the same time, the upper thinned portions 11B of each of the pinching members 11 can be relatively easily twisted because the upper thinned portions 11B are respectively lengthened. Therefore, an insertion resistance that can be generated when the spring clip 10 is fitted to the rib R of the instrument panel IP can be reduced. As a result, an insertion load (force) of the spring clip 10 that is required to fit the spring clip 10 to the rib R of the instrument panel IP can be effectively reduced.

Further, when the spring clip 10 is pressed toward the rib R of the instrument panel IP, the rib R can be introduced into the space formed between the pinching members 11 of the spring clip 10 while the engagement teeth 12A of the engagement strips 12 are elastically pressed to the plate surfaces Rs of the rib R. At this time, the peripheral edges having the shear drops 12A1 can contact the plate surfaces Rs of the rib R. Therefore, the spring clip 10 can be smoothly fitted to the rib R of the instrument panel IP. As a result, the insertion load of the spring clip 10 can be further reduced.

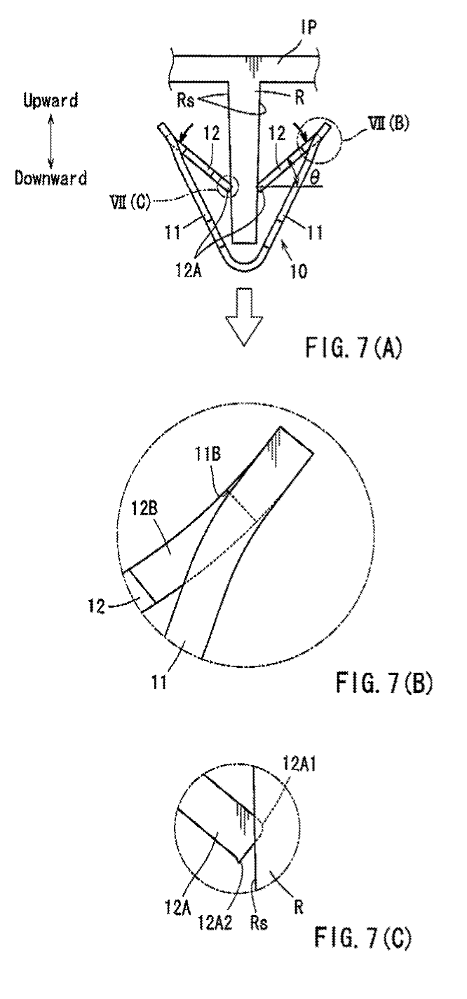

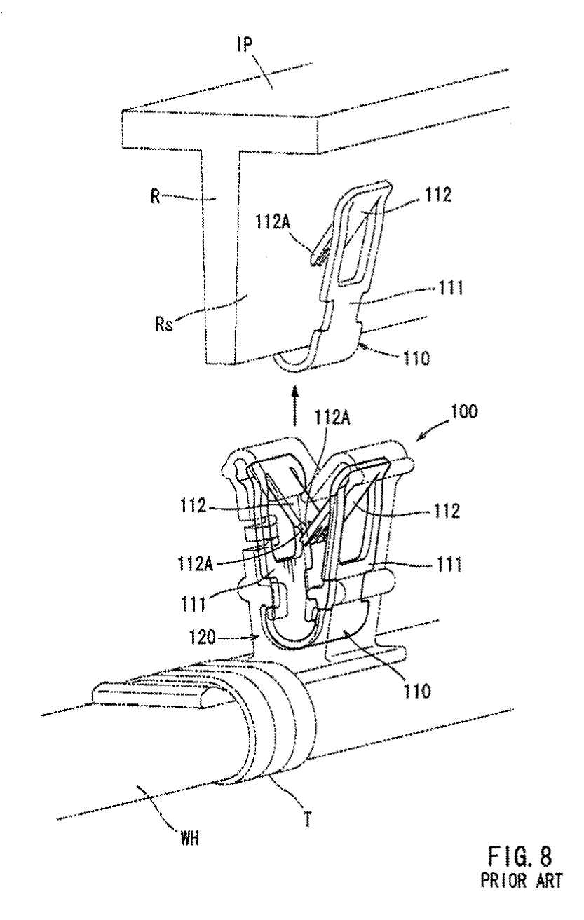

As shown in FIG. 7(A), in the engagement condition of the spring clip 10 and the rib R, when an extraction force is applied to the spring clip 10 of the clipping device 1 downwardly (i.e., in a direction shown by outline arrow), the spring clip 10 can be pulled downwardly. However, as shown in FIG. 7(C), the spring clip 10 can be deformed without being removed from the rib R of the instrument panel IP. In other words, the spring clip 10 can be deformed while the engagement condition of the spring clip 10 and the rib R is maintained.

In particular, when the extraction force is applied to the spring clip 10, a moment directed toward the upper opening of the spring clip 10 can be generated in each of the engagement strips 12 because the engagement teeth 12A of each of the engagement strips 12 are bitten into the plate surfaces Rs of the rib R. Due to the moment, as shown in FIG. 7(B), the proximal end portions 12B of the engagement strips 12 can be bent inwardly, i.e., toward the upper opening of the spring clip 10. Further, due to a bending force of the proximal end portions 12B of the engagement strips 12, the upper thinned portions 11B of each of the pinching members 11 of the spring clip 10 can also be twisted inwardly, i.e., toward the upper opening of the spring clip 10. Thus, as shown in FIG. 7(A), each of the engagement strips 12 can be deformed outwardly while rotating downwardly (i.e., in a rising direction with respect to the rib R) about the engagement teeth 12A that are bitten into the plate surfaces Rs of the rib R, so that each of the pinching members 11 can be widely spread outwardly.

As a result, a rake angle θ of the engagement teeth 12A to the plate surfaces Rs of the rib R can be reduced. In addition, the pinching members 11 can have an increased biasing (restoring) force, so that the engagement strips 12 can be strongly pressed against the plate surfaces Rs of the rib R. Therefore, the engagement teeth 12A formed in each of the engagement strips 12 can be strongly pressed to and bitten into the plate surfaces Rs of the rib R, so as to be effectively prevented from being slid downwardly while scraping the plate surface Rs. Thus, even when the extraction force is applied to the spring clip 10, the engagement condition of the spring clip 10 and the rib R can be reliably maintained, so that the spring clip 10 can be effectively prevented from being removed from the rib R of the instrument panel IP.

As described above, the proximal end portions 12B of the engagement strips 12 are narrowed or weakened, so as to be easily bent. In addition, the upper thinned portions 11B of each of the pinching members 11 are respectively lengthened, so as to be easily twisted. As a result, when the extraction force is applied to the spring clip 10, each of the engagement strips 12 can be easily deformed outwardly while rotating downwardly about the engagement teeth 12A that are bitten into the plate surfaces Rs of the rib R, so that each of the pinching members 11 can be widely spread outwardly before the engagement teeth 12A are applied with a large force that is capable of sliding the engagement teeth 12A downwardly while scraping the plate surfaces Rs. Therefore, even when the extraction force is applied to the spring clip 10, the spring clip 10 can be effectively prevented from being slipped off from the rib R of the instrument panel IP.

According to the spring clip 10, the proximal end portion 12B of the engagement strip 12 can be relatively easily bent outwardly. In addition, the upper thinned portions 11B of each of the pinching members 11 can be relatively easily twisted. Therefore, when the spring clip 10 is fitted to the rib R of the instrument panel IP, the insertion force of the spring clip 10 can be reduced. To the contrary, when the extraction force is applied to the spring clip 10 fitted to the rib R, the spring clip 10 can be effectively prevented from being slipped off from the rib R.

Further, according to the spring clip 10, the widened end portions 11A1 are formed in the U-shaped slot 11A of each of the pinching members 11. As a result, the proximal end portion 12B of the engagement strip 12 can be narrowed. At the same time, each of upper thinned portions 11B of each of the pinching members 11 can be lengthened to have the increased length identical to the width W1. Therefore, it is possible to easily to narrow the proximal end portion 12B of the engagement strip 12 and to lengthen each of upper thinned portions 11B without using complicated constructions.

Further, when the spring clip 10 is pressed toward the rib R of the instrument panel IP, the engagement teeth 12A of the engagement strips 12 can move along the plate surfaces Rs of the rib R while the peripheral edges having the shear drops 12A1 contact the same. Therefore, the insertion force of the spring clip 10 can be further reduced.

Naturally, various changes and modifications may be made to the present invention without departing from the scope of the invention. For example, in the embodiment, the widened end portions 11A1 may be formed in the U-shaped slot 11A of each of the pinching members 11, so that the proximal end portion 12B of each of the engagement strips 12 can be narrowed. However, the U-shaped slot 11A of each of the pinching members 11 can be gradually widened toward the end portions thereof, so that each of the engagement strips 12 can have a trapezoidal shape that is gradually narrowed upwardly.

Further, instead of forming the widened end portions 11A1 in the U-shaped slot 11A, one or more slots or apertures can be formed in the proximal end portion 12B of each of the engagement strips 12 such that the engagement strips 12 can be easily deformed. Further, in the embodiment, the pinching members 11 respectively have the engagement strips 12. However, the pinching members 11 can have a single engagement strip that is formed in one of the pinching members 11.

Further, in the embodiment, the engagement strips 12 may be shaped to be projected inwardly and downwardly and opposite to each other. However, the engagement strips 12 can be shaped to horizontally projected inwardly and opposite to each other. Further, in the embodiment, the engagement strips 12 may be formed by partially stamping out the pinching members 11. However, the engagement snips 12 can be formed by appropriately bending upper end portions of the pinching members 11.

In addition, in the embodiment, the engagement strips 12 may respectively have the engagement teeth 12A that mesh with each other. However, the engagement strips 12 can be positioned such that the engagement teeth 12A cannot mesh with each other. Further, the engagement teeth 12A can be omitted as necessary.

Further, the attachment arm 21 and the clip holding portion 22 of the clip body 20 can be appropriately modified as necessary. For example, the attachment arm 21 can be replaced with a tying belt that is capable of directly wrapping and binding the wiring harness WH. Further, the rib R of the instrument panel IP can be made of materials different from the synthetic resin of the instrument panel IP provided that the engagement strips 12 can be bitten into the rib R when the spring clip 10 is fitted thereto.

A representative example of the present invention has been described in detail with reference to the attached drawings. This detailed description is merely intended to teach a person of skill in the art further details for practicing preferred aspects of the present invention and is not intended to limit the scope of the invention. Only the claims define the scope of the claimed invention. Therefore, combinations of features and steps disclosed in the foregoing detail description may not be necessary to practice the invention in the broadest sense, and are instead taught merely to particularly describe detailed representative examples of the invention. Moreover, the various features taught in this specification may be combined in ways that are not specifically enumerated in order to obtain additional useful embodiments of the present invention.

What is claimed is:

1. A spring clip capable of being fitted to a plate-shaped member, comprising:
a pair of pinching members that are configured to receive the plate-shaped member in a space formed therebetween when the spring clip is fitted to the plate-shaped member, and
at least one engagement strip that is formed in the pinching members so as to be projected into the space formed between the pinching members,
wherein the at least one engagement strip is arranged and constructed to be elastically deformed when the plate-shaped member is received in the space formed between the pinching members, so that a contacting peripheral edge of the at least one engagement strip can be elastically pressed to the plate-shaped member due to an elastically biasing force that can be produced by deformation of the at least one engagement strip, and
wherein the at least one engagement strip has a weakened portion formed in a proximal end portion thereof, so as to be easily deformed.

2. The spring clip as defined in claim 1, wherein the at least one engagement strip is formed by partially cutting out the pinching members, and wherein the weakened portion is formed by forming a removed portion in the proximal end portion of the at least one engagement strip.

3. The spring clip as defined in claim 1, wherein the at least one engagement strip is formed by stamping out the pinching members, and wherein the at least one engagement strip is stamped out such that a rounded shear drop can be formed in the contacting peripheral edge of the at least one engagement strip.

4. The spring clip as defined in claim 1, wherein the at least one engagement strip comprises engagement teeth that are formed in a distal end thereof, and wherein the contacting peripheral edge is formed in the engagement teeth.

5. The spring clip as defined in claim 1, wherein the at least one engagement strip comprises a pair of engagement strips, and wherein the engagement strips are respectively formed in the pinching members so as to be projected opposite to each other into the space formed between the pinching members.

6. A clipping device, comprising:
a clip body, and
a spring clip that is fitted within the clip body and is capable of being fitted to a plate-shaped member, the spring clip comprising:
a pair of pinching members that are configured to receive the plate-shaped member in a space formed therebetween when the spring clip is fitted to the plate-shaped member, and
at least one engagement strip that is formed in the pinching members so as to be projected into the space formed between the pinching members,
wherein the at least one engagement strip is arranged and constructed to be elastically deformed when the plate-shaped member is received in the space formed between the pinching members, so that a contacting peripheral edge of the at least one engagement strip can be elastically pressed to the plate-shaped member due to an elastically biasing force that can be produced by deformation of the at least one engagement strip, and
wherein the at least one engagement strip has a weakened portion formed in a proximal end portion thereof, so as to be easily deformed.
